(19) United States
(12) Patent Application Publication
(10) Pub. No.: US 2021/0329918 A1
(43) Pub. Date: Oct. 28, 2021

(54) AQUEOUS COMPOSITIONS OF TOPRAMEZONE

(71) Applicant: BASF SE, Ludwigshafen am Rhein (DE)

(72) Inventors: Shawn Dickess, Cincinnati, OH (US); Dean A Dester, Cincinnati, OH (US)

(21) Appl. No.: 17/270,515

(22) PCT Filed: Aug. 12, 2019
(86) PCT No.: PCT/EP2019/071527

§ 371 Date: Feb. 23, 2021

Related U.S. Application Data
(60) Provisional application No. 62/723,033, filed on Aug. 27, 2018.

(30) Foreign Application Priority Data
Sep. 17, 2018 (EP) 18194761.5

(51) Int. Cl. A01N 43/80; A01N 25/24; A01N 25/04; A01N 25/30

(52) U.S. Cl. CPC A01N 43/80; A01N 25/30; A01N 25/04; A01N 25/24

(57) ABSTRACT

Described herein is an aqueous herbicidal composition including topramezone. Also described herein is an aqueous solution of topramezone in a buffer solution with or without adjuvants. Also described herein is a method of using these compositions for controlling undesirable vegetation in crops and non-crops.

### FIELD OF INVENTION

The presently claimed invention relates to a herbicidal aqueous compositions comprising topramezone. The present invention also relates to the use of these compositions for controlling undesirable vegetation in crops and non-crops. Non-crop areas include tufts, lawns, golf courses, or parks.

### BACKGROUND OF THE INVENTION

In crop protection, it is desirable in principle to increase the specificity and the reliability of the action of active compounds. Particularly, it is desirable for the crop protection products to control the harmful plants effectively and, at the same time, to be tolerated by the useful plants in question.

Herbicides find widespread use in commercial agriculture and have enabled an increase in crop yields and product quality. They are routinely used to control various weeds, for example, grasses and broadleaved weeds such as amaranthus, foxtails and others, whenever these weeds pose risks to crop yield.

Topramezone (4-[3-(4,5-dihydro-1,2-oxazol-3-yl)-2-methyl-4-methyl sulfonyl benzoyl]-2-methyl-1H-pyrazol-3-one), as well as its agriculturally acceptable salts are well known herbicide active compounds [see C. D. S Tomlin (Ed.), The Pesticide Manual, 14th ed., 2006, BCPC Alton, Hampshire, UK, p. 1047]. Topramezone and a general procedure for its preparation are known from the PCT applications WO 98/31681 and W099/58509.

Topramezone is known to be an inhibitor of 4-hydroxyphenylpyruvatdioxygenase (4-HPPD inhibitor) and provides a highly effective control of annual warm season grasses such as Echinochloa, Setaria Digitaria and Panicum species, and of dicotyledonous weeds, like Chenopodium, Atriplex, Amaranthus, Solanum, Galinsoga, Stellaria media, Lamium, and Veronica-species. The herbicidal activity and the activity spectrum, however, are sometimes limited. Commercially formulation oftopramezone are recommended to be applied in combination with adjuvants such as Dash® to achieve a reliable herbicidal action. Formulations of topramezone are marketed by BASF SE under the tradenames Clio® and Clio® super (co-formulation of topramezone with dimethenamid-P).

Topramezone is often formulated as a water dispersible granule (WG) or as a suspension concentrate (SC), i.e., a solid suspension. In such formulations, the active ingredients may be milled to a particular size and the solid subsequently suspended in an aqueous-based carrier vehicle. The WG formulation is typically made with inert compounds that have little adjuvancy and it can be difficult to make the active ingredient bioavailable to control weeds. The particulate size of the active ingredient in these formulations, and during application, often remains too large such that a substantial amount of the formulation must be applied per acre to control weeds. Similarly, a suspension concentrate formulation has the disadvantage that adjuvants are hard to incorporate at a useful rate and they provide little impetus for foliar uptake and biotranslocation, and thus a substantial amount of the formulation must be applied per acre to control weed infestations.

Therefore, it is an object of the present invention to provide an aqueous solution formulation of topramezone which would be readily amenable for use and is readily bioavailable.

### SUMMARY OF THE INVENTION

It has been surprisingly found that topramezone readily solubilizes in an aqueous solution having a pH from 6.5 to 7.5 when measured at 25° C.

Thus, in one aspect, the present invention relates to an aqueous solution comprising from 0.1 wt. % to 1.0 wt. % of topramezone and the solution has a pH range of from 6.5 to 7.5 when measured at 25° C.

In another aspect, the present invention relates to an aqueous solution comprising from 0.1 wt. % to 1.0 wt. % topramezone and a buffering agent.

In yet another aspect, the present invention relates to an aqueous buffer solution comprising from 0.1 wt. % to 1.0 wt. % topramezone and an adjuvant, wherein the solution has a pH range of from 6.5 to 7.5 when measured at 25° C.

In a further embodiment of the present invention, the adjuvant is a non-ionic surfactant present in a range of from 0.1% to 10.0% to the total weight of the composition.

In another embodiment of the present invention the non-ionic surfactant is selected from the group of alkyl polyglycoside, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols and ethylene oxide/propylene oxide copolymer.

In an aspect of the present invention, the aqueous buffer solution comprising from 0.1wt. % to 1.0 wt. % topramezone and an adjuvant, wherein the solution has a pH range of from 6.5 to 7.5 when measured at 25° C. is stable for a period of at least 135 days when stored at 50° C.

In an aspect, the present invention relates to a method of controlling the undesired vegetation by applying the aqueous buffered composition comprising topramezone in from 0.1 wt. % to 1.0 wt. % with or without an adjuvant.

In yet another aspect, the present invention relates to the use of the aqueous buffered composition comprising topramezone from 0.1 wt. % to 1.0 wt. % with or without an adjuvant for controlling the undesired vegetation.

### DETAILED DESCRIPTION OF THE INVENTION

Before the present compositions and formulations of the invention are described, it is to be understood that this invention is not limited to compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range from 1 to 10 implies that both 1 and 10 are included in the range. For the avoidance of doubt, applicant shall be entitled to any equivalents according to applicable law.

The term “stable” as used herein refers to an aqueous composition comprising topramezone wherein the formulation remains unchanged i.e. without any precipitation or turbidity or phase separation.

In one aspect of the present invention, the present invention relates to an aqueous solution comprising from 0.1% to 1.0% of topramezone and the solution has a pH range of from 6.5 to 7.5 when measured at 25° C.

Topramezone is a selective herbicide in the phenyl pyrazolyl ketone chemical family used for postemergence control mainly of broadleaf weeds as well as some grasses in field maize, sweet maize, and popcorn. It is represented by the following structure

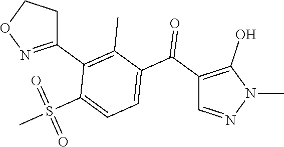 [SMILES: Cc1c(C(=O)c2cnn(C)c2O)ccc(S(C)(=O)=O)c1C1=NOCC1]

The solubility of topramezone in water is about 0.305 g/L at 25° C. Further the solubility of topramezone is various organic solvents is also limited.

It has been surprisingly found that the topramezone readily solubilizes in aqueous solution having a pH of from 6.5 to 7.5 when measured at 25° C.

In another aspect, the present invention relates to an aqueous solution comprising from 0.1 wt. % to 1.0 wt. % topramezone and a buffering agent. In an embodiment, the amount of Topramezone is in the range of from 0.1 to 1.0% or 0.1 to 0.9% or 0.1 to 0.8% or 0.1 to 0.7% or 0.1 to 0.6% or 0.1 to 0.5% or 0.1 to 0.4% or 0.1 to 0.3% or 0.1 to 0.2%, in each case based on the final weight of the composition.

In an embodiment of the present invention the at least one buffer is selected from the group consisting of phosphate buffer, phosphate-acetate buffer, citrate-phosphate buffer, BES (N,N-bis(2-hydroxyethyl)-2-aminoethanesulfonaic acid)-buffered saline, EBSS (Earle's balanced salt solution) buffer, Hanks balanced buffer solution, HEPPSO (N-(2-hydroxyethyl)piperazine-N′-(2-hydroxypropanesulfonic acid) buffer, Hank's buffer with HEPES, imidazole-HCl buffer, maleic acid buffer, MOPS (3-(N-morpholino)propane-sulfonic acid) buffer, phosphate buffer saline, potassium phosphate, TBS (Tris buffered saline) buffer, and Tris (tris(hydroxymethyl) aminomethane) buffer.

In an embodiment of the present invention, the at least one buffering agent is a phosphate buffer.

The phosphate buffer may optionally contain other buffering agents in addition to phosphate.

For example, the phosphate buffers may contain citrate. In one embodiment, however, the phosphate buffers contain no other buffering agents.

The phosphate buffer used in the formulations of the present invention may be an alkaline metal or alkaline earth metal phosphate buffer such as a sodium phosphate buffer.

Accordingly, in another embodiment, the present invention provides a composition, wherein the phosphate buffer comprises sodium phosphate dibasic, sodium hydroxide, potassium dihydrogen phosphate and has a pH of 7±0.01 when measured at 25° C.

The sodium phosphate used to prepare the formulations of the invention can be, for example, sodium dihydrogen phosphate or disodium hydrogen phosphate or mixtures thereof.

The sodium phosphate (e.g. the sodium dihydrogen phosphate or disodium hydrogen phosphate or mixtures thereof) can be used in anhydrous form, or in hydrated forms, or mixtures of anhydrous and hydrated forms. For example, sodium dihydrogen phosphate may be used in the form of its monohydrate whereas di-sodium hydrogen phosphate may be used in the form of its dihydrate.

Therefore, in one embodiment, the phosphate buffer is sodium dihydrogen phosphate (e.g. the monohydrate thereof).

In another embodiment, the phosphate buffer is di-sodium hydrogen phosphate (e.g. the dihydrate thereof)

In a further embodiment, the phosphate buffer is a combination of more than one sodium phosphate buffer. For example, the phosphate buffer can be a combination of two sodium phosphate buffers. In one particular embodiment, the formulation contains first and second sodium phosphate buffers wherein the first sodium phosphate buffer is sodium dihydrogen phosphate (e.g. in monohydrate form) and the second sodium phosphate buffer is di-sodium hydrogen phosphate (e.g. in dihydrate form).

It will be appreciated that the proportions of sodium dihydrogen phosphate and disodium hydrogen phosphate can be varied to provide a desired pH value for the formulation. Where necessary, acid or base may be added to make adjustments to the final pH.

Similarly, where only one of sodium dihydrogen phosphate and disodium hydrogen phosphate is used to prepare the formulation, acid or base may be added to adjust the pH of the formulation to the required value.

In an embodiment of the present invention, the pH of the aqueous composition is in the range of from 6.5 to 7.5, more preferably from 6.8 to 7.2, even more preferably from 6.9 to 7.1 when measured at 25° C.

In another embodiment of the present invention, the pH of the aqueous composition is 6.5±0.01, 6.6±0.01, 6.7±0.01, 6.8±0.01, 6.9±0.01, 7.0±0.01, 7.1±0.01, 7.2±0.01, 7.3±0.01, 7.4±0.01 or 7.5±0.01 when measured at 25° C.

In further embodiment, present invention relates to an aqueous solution comprising from 0.1% to 1.0 wt. % topramezone and an adjuvant wherein the solution has a pH range of from 6.5 to 7.5 when measured at 25° C.

‘Adjuvant’ is understood to be a compound which increases the effectiveness of the active ingredient, when applied for the treatment of soil and plants. By the term ‘effectiveness’ it is meant that the adjuvant leads to one or more of the following effects:
increased the activity of the active ingredient
increased absorption of the active ingredient and spread on the target surface,
increased rain fastness of the active ingredient,
increased compatibility of the active ingredient with fertilizer and/or micronutrients and/or other components in the spray solution
decrease in the photo transformation of the active ingredient,
decrease in the amount of driftable droplets from the spray solution
decrease in the amount of foam in the spray solution.

In an embodiment of the present invention, the adjuvant is a non-ionic surfactant.

The nonionic surfactants are preferably selected from the group of alkyl polyglycoside, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols and ethylene oxide/propylene oxide copolymer.

In an embodiment of the present invention, the non-ionic surfactant is an alkyl polyglycoside which is represented by the formula (I)

R₁O(R₂O)_{b}(Z)ₐ (I)

wherein:
R₁ is straight-chain or branched, unsubstituted or substituted C4-C30 alkyl or straight-chain or branched, unsubstituted or substituted C4-C30 alkenyl;
R₂ is straight-chain or branched, unsubstituted or substituted C2-C4 alkylene;
b is 0 to 100
Z is a saccharide residue having about 5 to about 6 carbon atoms; and
a is an integer from 1 to 6.

In another embodiment the alkyl polyglycoside represented by the formula(I) has the following substitution
R₁ is straight chain or branched chain, unsubstituted or substituted C4-22 alkyl straight chain or branched chain, unsubstituted or substituted C4-C22 alkenyl group,
R₂ is straight chain C2-C4 alkylene.
b is 0 to about 12
Z is a saccharide residue having about 5 to about 6 carbon atoms. Z may be glucose, mannose, fructose, galactose, talose, gulose, altrose, allose, apiose, gallose, idose, ribose, arabinose, xylose, lyxose, or a mixture thereof.
‘a’ is an integer from 1 to about 3,

Even more preferably the alkyl polyglycoside represented by the formula(I) has the following substitution
R₁ is straight-chain or branched, unsubstituted C8-C16 alkyl;
b is 0;
Z is glucose: and
a is an integer from 1 to 2.

Typical compounds of formula (I) are compounds of formula (Ia):

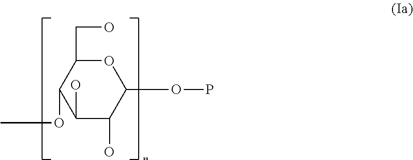

where n is the degree of polymerization and is from 1 to 3, preferably 1 or 2, and P is a branched or straight chain alkyl group having from 4 to 18 carbon atoms or a mixture of alkyl groups having from 4 to 18 carbon atoms. Most typically, the alkyl polyglucoside(APG) comprises an alkyl group containing 8-10 carbon atoms and has an average degree of polymerization of 1.7; an alkyl group containing 9-11 carbon atoms and has an average degree of polymerization of 1.3 to 1.6; or a-mixture thereof APG also includes embodiments, such as those described above, which have been anionically or cationically modified.

Exemplary alkyl polyglycosides include APG® 325 (BASF) (an alkyl polyglycoside in which the alkyl group contains 9 to 11 carbon atoms and has an average degree of polymerization of 1.6), PLANTAREN® 2000 (BASF) (an alkyl polyglycoside in which the alkyl group contains 8 to 16 carbon atoms and has an average degree of polymerization of 1.4), PLANTAREN® 1300 (BASF (an alkyl polyglycoside in which the alkyl group contains 12 to 16 carbon atoms and has an average degree of polymerization of 1.6), AGNIQUE® PG 8107 (BASF) (an alkyl polyglycoside in which the alkyl group contains 8 to 10 carbon atoms and has an average degree of polymerization of 1.7), AGNIQUE® PG 9116 (BASF) (an alkyl polyglycoside in which the alkyl group contains 9 to 11 carbon atoms and has an average degree of polymerization of 1.6) and AGNIQUE® PG 8105 (BASF) (an alkyl polyglycoside in which the alkyl group contains 8 to 10 carbon atoms and has an average degree of polymerization of 1.5).

In an embodiment, the alkyl polyglycoside is a C9-C11 alkyl polyglucoside.

In another embodiment of the present invention, the non-ionic surfactant is an alkoxylated alcohol represented by formula (II)

R₃O—(R₄O)ₓR₅ (II)
wherein:
R₃ is straight-chain or branched, unsubstituted or substituted C1-C30 alkyl or straight-chain or branched, unsubstituted or substituted C2-C30 alkenyl,
R₄ in each of the x (R₄O) groups is independently straight-chain or branched, un-substituted or substituted C2-C4 alkylene,
R₅ is hydrogen, or straight-chain or branched, unsubstituted or substituted C1-C30 alkyl straight-chain and
x is an integer from 1 to 60.

In an embodiment of the present invention, the alkoxylated alcohol represented by formula II has the following substitution
R₃ is straight-chain or branched, unsubstituted C10-C14 alkyl;
R₄ is unsubstituted, straight-chain C2 alkylene;
R₅ is hydrogen and
x is an integer in the range of 7 to 10.

Nonlimiting examples include ethoxylated long chain C10-Guerbet alcohols, such as those produced by BASF and sold under the trade names LUTENSOL® XL100, LUTENSOL® XL80, LUTENSOL® XL70, LUTENSOL® XL60 and LUTENSOL® XP80 and. Examples include LUTENSOL XL80—an ethoxylated C10-Guerbet alcohol with an average of 8 ethylene oxide (EO) groups, LUTENSOL® XL100—an ethoxylated C10-Guerbet alcohol with an average of 10 EO groups, and an ethoxylated C10-Guerbet alcohol having an HLB of about 13, such as the surfactant produced by BASF Corp. and sold under the trade name LUTENSOL® XL70.

Other examples of suitable nonionic surfactants include ethoxylated linear alcohols, such as ethoxylated linear alcohols having a C10-C15 n-alkyl group. Nonlimiting examples include LUTENSOL® TDA 10 (produced by BASF)—an ethoxylated tridecyl alcohol having an average of 10 EO groups, Genapol® LA 070S—an ethoxylated lauryl alcohol having an average of 7 EO groups, Tomadol® 91-6-a C9-C11 ethoxylated alcohol having an average of 6 EO groups, and LUTENSOL® AO-8 a synthetic C13-C15 ethoxylated oxo alcohol having an average of 8 EO groups.

In another embodiment of the present invention, the alkoxylated alcohol is ethoxylated tridecyl alcohol.

In an embodiment of the present invention, the non-ionic surfactant is an alkoxylated natural oil.

The natural oil is selected from the group of castor oil, soybean oil, peanut oil, sunflower oil, rapeseed oil, palm oil, cottonseed oil, groundnut oil, palm kernel oil, coconut oil, olive oil, corn oil, grape seed oil, linseed oil, safflower oil, sesame oil, maize oil, lesquerella oil, sesame oil, cotton oil, jatropha oil, fish oil, herring oil, sardine oil, tallow, lard, or a mixture thereof.

An “alkoxylated natural oil” means a natural oil that has been functionalized with groups of the formula —(L-O)n-H or -A-O—(L-O)n-H, where L is a straight or branched C2-C3 alkylene group, n is an integer greater than or equal to 1 (e.g., n is selected from integers from 1 to 100), and A is a bond or a divalent linking group). Divalent linking groups can be any suitable chemical group that attaches the remainder of the functional group to the natural oil. Examples of divalent linking groups include C1-C6 alkylene groups, such as methylene. Several chemistries known to those skilled in the art can be used to alkoxylate natural oils. Certain natural oils, such as castor oil, comprise triglycerides that contain hydroxylated fatty acids (e.g., ricinoleic acid) and may be alkoxylated without further modification. Other natural oils that do not contain sufficient quantities of hydroxylated fatty acids, but that do contain unsaturated fatty acids may be modified to incorporate hydroxyl groups that may be alkoxylated. The term “alkoxylated natural oil”, as used herein, is intended to encompass both natural oils, such as castor oil, that may be alkoxylated without further modification, and natural oils that must be modified to incorporate hydroxyl groups that can then be alkoxylated. Such modifications include modification at carbon-carbon double bonds to incorporate hydroxyl groups, for example, by epoxidation and nucleophilic ring-opening, hydroxylation, ozonolysis and reduction, and hydroformylation and reduction (to introduce hydroxymethyl groups).Such modifications are commonly known in the art and are described, for example, in U.S. Pat. Nos. 4,534,907, 4,640,801, 6, 107,433, 6, 121,398, 6,897,283, 6,891,053,6,962,636, 6,979,477, and PCT publication Nos. WO 2004/020497, WO 2004/096744,WO 2004/096882, and WO 2004/096883.

After the modification of the natural oils, the modified products may be alkoxylated through the use of C2-C3 alkylene oxides, including ethylene oxide (EO), propylene oxide (PO) and mixtures of EO with PO according to methods familiar to those skilled in the art, such as base catalyzed or acid-catalyzed ring-opening polymerization (see e.g. U.S. Pat. Nos. 2,870,220; 2, 133,480; 2,481,278). Alternatively, hydroxyl-containing natural oils or hydroxyl-containing modified natural oils can be alkoxylated by reaction with an alkylene glycol (e.g., ethylene glycol or propylene glycol, or a mixture thereof) or a hydroxy-terminated oligo- and poly (alkylene glycol) s (e.g. hexaethylene glycol, poly(ethylene glycol) with Mn=300 available from Sigma-Aldrich Co., St. Louis, Mo. (Sigma-Aldrich Cat. No. 202371), or poly(ethylene glycol) with Mn=400 available from Sigma-Aldrich Co., St. Louis, Mo. (Sigma-Aldrich Cat. No. 202398) in the presence of a dehydration agent. Suitable reaction conditions are well known in the art, for example, see U.S. Pat. No. 2,056,830 and EP 2 080 778.

In certain embodiments, the alkoxylated natural oil is ethoxylated (i.e., L is ethylene). In certain embodiments, the ethoxylated natural oil contains an average of about 15 moles to about 50 moles of ethylene oxide per mole of natural oil (e.g., n is about 15 to about 50). In certain other embodiments, the ethoxylated natural oil contains an average of about 25 moles to about 40 moles of ethylene oxide per mole of natural oil (e.g. n is about 25 to about 40). In certain other embodiments, the ethoxylated natural oil contains an average of about 30 moles to about 40 moles of ethylene oxide per mole of natural oil (e.g. n is about 30 to about 40). In certain other embodiments, the ethoxylated natural oil contains an average of about 30 moles to about 36 moles of ethylene oxide per mole of natural oil (e.g. n is about 30 to about 36). In certain other embodiments, the ethoxylated natural oil contains an average of about 36 moles of ethylene oxide per mole of natural oil (e.g., n is about 36). In certain other embodiments, the ethoxylated natural oil contains an average of about 30 moles of ethylene oxide per mole of natural oil (e.g. n is about 30).

In a further embodiment of the present invention, the alkoxylated natural oil is ethoxylated castor oil.

The ethoxylated castor oil may be one or more ethoxylated castor oils selected from the group of ethoxylated castor oils having an EO number of 8 to 50. Preferably the ethoxylated castor oil has an EO number of 15 to 40. In an embodiment the ethoxylated castor oil has an EO number of 20 to 40, for example, Agnique® CSO-25 and Agnique® CSO-36 (available from BASF).

In an embodiment of the present invention, the amount of adjuvant is from 0.1 to 10% or 0.1% to 9% or 0.1 to 8% or 0.1 to 7% or 0.1 to 6% or 0.1 to 5% or 0.1 to 4% or 0.1 to 3% or 0.1 to 2% or 0.1 to 1%, more preferably in the range of 0.1 to 2.5% or 0.1 to 2.25% or 0.1 to 1.75% or 0.1 to 1.5% or 0.1 to 1.25% in each case based on the final weight of the composition.

In another embodiment of the present invention, the pH of the aqueous composition comprising topramezone in from 0.1 wt. % to 1.0 wt. % and an adjuvant in from 0.1% to 10.0 wt. % is 6.5±0.01, 6.6±0.01, 6.7±0.01, 6.8±0.01, 6.9±0.01, 7.0±0.01, 7.1±0.01, 7.2±0.01, 7.3±0.01, 7.4±0.01, 7.5±0.01 when measured at 25° C.

In an embodiment of the present invention, the aqueous buffer solution comprising from 0.1 wt. % to 1.0 wt. % topramezone and an adjuvant, wherein the solution has a pH from 6.5 to 7.5 when measured at 25° C. is stable for a period of at least 135 days when stored at 50° C.

### Additives/Auxiliary Agents

The composition of the presently claimed invention may further comprise at least one additive/auxiliary compound selected from the group of anti-foaming agent thickeners, bactericides, anti-freezing agents, colorants, and adhesives.

The composition comprises anti-foaming agents. Non-limiting examples of suitable anti-foaming agents include silicone emulsions such as for example Silikon SRE from Wacker Germany or Rhodorsil from Rhodia, France; long chain alcohols; fatty acids; salts of fatty acids; organofluorine compounds and their mixtures

Suitable thickeners are polysaccharides, for e.g. xanthan gum, carboxymethyl cellulose, organic clays (organically modified or unmodified), polycarboxylates and silicates.

Suitable anti-freezing agents are ethylene glycol, propylene glycol, urea and glycerine.

Suitable bactericides are bronopol and isothiazolinone derivatives such as alkylisothiazolinones and benzisothiazolinones

Suitable colorants include both pigments, which are sparingly soluble in water, and dyes, which are soluble in water. Non-limiting examples are Rhodamin B, C. I. Pigment Red 112 and C. I. Solvent Red 1, Pigment Blue 15:4, Pigment Blue 15:3, Pigment Blue 15:2, 35 Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown, 25, Basic Violet 10, Basic Violet 49, Acid Red 51, Acid Red 52, Acid Red 14, Acid Blue 9, Acid Yellow 23, Basic Red 10, Basic Red 108, iron oxide, titanium oxide, iron hexacyanoferrate.

Suitable adhesives are polyvinyl pyrrolidone, polyvinyl acetates, polyvinyl alcohols, polyacrylates, biological or synthetic waxes, and cellulose ethers.

In an embodiment of the present invention, the amount of the auxiliary agents is from 0.1 to 10% or 0.1 to 9% or 0.1 to 8% or 0.1 to 7% or 0.1 to 6% or 0.1 to 5% or 0.1 to 4% or 0.1 to 3% or 0.1 to 2% or 0.1 to 1%, more preferably in the range of 0.1 to 2.5% or 0.1 to 2.25% or 0.1 to 1.75% or 0.1 to 1.5% or 0.1 to 1.25% in each case based on the final weight of the composition.

In a further embodiment, individual components of the composition according to the invention may be mixed in a spray tank and further additives/auxiliary agents may be added, if appropriate.

The composition according to the presently claimed invention can be applied from a pre-dosage device, a knapsack sprayer, a spray tank, a spray plane, or an irrigation system.

The compositions of the present invention are suitable for controlling a large number of harmful plants, including monocotyledonous weeds and dicotyledonous weeds. They are in particular for controlling annual weeds such as gramineous weeds (grasses) including Echinochloa species such as barnyardgrass (Echinochloa crusgalli var. crusgalli), Digitaria species such as crabgrass (Digitaria sanguinalis), Setaria species such as green foxtail (Setaria vindis) and giant foxtail (Setaria faberii), Sorghum species such as johnsongrass (Sorghum halepense Pers.), Avena species such as wild oats (Avena fatua), Cenchrus species such as Cenchrus echinatus, Bromus species, Lolium species, Phalaris species, Eriochloa species, Panicum species, Brachiaria species, annual bluegrass (Poa annua), blackgrass (Alopecurus myosuroides), Aegilops cylindrica, Agropyron repens, Apera spicaventi, Eleusine indica, Cynodon dactylon and the like. The compositions of the present invention are also suitable for controlling a large number of dicotyledonous weeds, in particular broad leaf weeds including particular broadleaf weeds including Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisllfolia), Acanthospermum species, Anthemis species, Atriplex species, Cirsium species, Convolvulus species, Conyza species, such as horseweed (Conyza canadensis), Cassia species, Commelina species, Datura species, Euphorbia species, Geranium species, Galinsoga species, morningglory (Ipomoea species), Lamium species, Malva species, Matricaria species, Sysimbrium species, Solanum species, Xanthium species, Veronica species, Viola species, common chickweed (Stellaria media), velvetleaf (Abutilon theophrasti), Hemp sesbania (Sesbania exaltata Cory), Anoda cristata, Bidens pllosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia braslliensis, and the like.

The compositions of the present invention are suitable for combating/controlling undesired vegetation in plants their environment and/or seeds. The plants include crops and non-crops.

The compositions of the present invention are suitable for combating/controlling undesired vegetation in small-grain cereal crops, such as wheat, durum, triticale, rye and barley.

The compositions ofthe present invention are suitable for combating/controlling undesired vegetation in non-crop areas include tufts, lawns, golf courses, or parks.

If not stated otherwise, the compositions of the invention are suitable for application in any variety of the aforementioned crop plants.

The compositions according to the invention can also be used in crop plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutgenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names Roundup Ready® (glyphosate tolerant, Monsanto, USA), Cultivance® (imidazolinone tolerant, BASF SE, Germany) and Liberty Link® (glufosinate tolerant, Bayer CropScience, Germany).

The compositions according to the invention can also be used in genetically modified crop plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

The compositions according to the invention can also be used in crop plants that have been modified, e.g. by the use of recombinant DNA techniques to be capable of synthesizing one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

The compositions according to the invention can also be used in crop plants that have been modified, e.g. using recombinant DNA techniques to be capable of synthesizing one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato cultivars, which express resistance genes acting against Phytophthora infestans derived from the Mexican wild potato, Solanum bulbocastanum) or T4-lysozym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above.

The compositions according to the invention can also be used in crop plants that have been modified, e.g. using recombinant DNA techniques to be capable of synthesizing one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

The compositions according to the invention can also be used in crop plants that have been modified, e.g. using recombinant DNA techniques to be capable of producing an increased amount of ingredients or new ingredients, which are suitable to improve human or animal nutrition, e.g., oil crops that produce health-promoting long-chain omega-3 fatty acids or unsaturated omega-9 fatty acids (e.g., Nexera® rape, Dow AgroSciences, Canada).

The compositions of the present invention can be applied in a conventional manner by a skilled personal familiar with the techniques of applying herbicides. Suitable techniques include spraying, atomizing, dusting, spreading or watering. The type of application depends on the intended purpose in a well-known manner, in any case, they should ensure the finest possible distribution of the active ingredients according to the invention.

The compositions can be applied pre-emergence or post-emergence, i.e. before, during and/or after emergence of the undesirable plants. When the compositions are used in crops, they can be applied after seeding and before or after the emergence of the crop plants. The compositions invention can, however, also be applied prior to seeding of the crop plants.

The compositions according to the invention exhibits very good post-emergence herbicide activity, i.e. they show a good herbicidal activity against emerged undesirable plants. Thus, in an embodiment of invention, the compositions are applied post-emergence, i.e. during and/or after, the emergence of the undesirable plants. It is particularly advantageous to apply the mixtures according to the invention post emergent when the undesirable plant starts with leaf development up to flowering. Since the compositions of the present invention show good crop tolerance, even when the crop has already emerged, they can be applied after seeding of the crop plants and in particular during or after the emergence of the crop plants.

The compositions are applied to the plants mainly by spraying, in particular foliar spraying. Application can be carried out by customary spraying techniques using, for example, water as carrier and spray liquor rates of 10 to 2000 1/ha or 50 to 1000 1/ha (for example from 100 to 500 1/ha).

In the case of a post-emergence treatment of the plants, the herbicidal mixtures or compositions according to the invention are preferably applied by foliar application. Application may be affected, for example, by usual spraying techniques with water as the carrier, using amounts of spray mixture of approx. 50 to 10001/ha.

In the method of the invention, the application rate of the composition of the present invention calculated as topramezone, is from generally from 5 to 50 g/ha and preferably from 8 to 25 g/ha.

In an embodiment, 20 to 2000 litres, preferably 50 to 400 litres, of the ready-to-use spray liquid are applied per hectare of agricultural useful area.

For use in treating crop plants, e.g. by foliar application, the rate of application of the topramezone composition of this invention may be in the range of 0.0001 g to 4000 g per hectare, e.g. from 1 to 2 kg per hectare or from 1 g to 750 g per hectare, desirably from 1 g to 100 g per hectare, more desirably from 10 g to 50 g per hectare, e.g., 10 to 20 g per hectare, 20 to 30 g per hectare, 30 to 40 g per hectare, or 40 to 50 g per hectare.

### Embodiments

1. An aqueous composition comprising 0.1 wt. % to 1.0 wt. % topramezone or an agriculturally acceptable salt thereof, based on the overall weight of the aqueous composition, wherein the pH of the composition is in the range from 6.5 to 7.5.
2. The aqueous composition according to embodiment 1, wherein the amount oftopramezone or an agriculturally acceptable salt thereof is in the range of 0.1 wt. % to 0.5 wt. %, based on the overall weight of the aqueous composition.
3. The aqueous composition according to embodiment 1, wherein the pH of the composition is in the range of from 6.8 to 7.2.
4. The aqueous composition according to embodiment 1, wherein the pH of the composition is in the range of from 6.9 to 7.1.
5. The aqueous composition according to embodiment 1, comprising at least one buffering agent.
6. The aqueous composition according to embodiment 5, wherein the at least one buffering agent is selected from the group of phosphate buffer, phosphate-acetate buffer, citrate-phosphate buffer, BES (N,N-bis(2-hydroxyethyl)-2-aminoethanesulfonaic acid)-buffered saline, EBSS(Earle's balanced salt solution) buffer, Hanks balanced buffer solution, HEPPSO (N-(2-hydroxyethyl)piperazine-N′-(2-hydroxypropanesulfonic acid) buffer, Hank's buffer with HEPES, imidazole-HCl buffer, maleic acid buffer, MOPS (3-(N-morpholino)propane-sulfonic acid) buffer, phosphate buffer saline, phosphate buffer, potassium phosphate, TBS Tris buffered saline buffer, and Tris (tris(hydroxymethyl) aminomethane) buffer.
7. The aqueous composition according to any one of embodiment 1 to 6 further comprising at least one adjuvant.
8. The aqueous composition according to embodiment 7, wherein the at least one adjuvant is a non-ionic surfactant.
9. The aqueous composition according to embodiment 8, wherein the non-ionic surfactant is selected from the group of alkyl polyglycoside, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols, ethylene oxide/propylene oxide copolymer and mixtures thereof.
10. The aqueous composition according to embodiment 9, wherein the alkyl polyglycoside is represented by the formula (I)

R₁O(R₂O)_{b}(Z)ₐ (I)

wherein:
R₁ is straight-chain or branched, unsubstituted or substituted C4-C30 alkyl or straight-chain or branched, unsubstituted or substituted C4-C30 alkenyl;
R₂ is straight-chain or branched, unsubstituted or substituted C2-C4 alkylene;
b is in the range of 0 to 100
Z is a saccharide residue having 5 to 6 carbon atoms; and
a is an integer in the range of 1 to 6.
11. The aqueous composition according to embodiment 10, wherein
   R₁ is straight-chain or branched, unsubstituted C8-C16 alkyl;
   b is 0;
   Z is glucose; and
   a is an integer from 1 to 2.
12. The aqueous composition according to embodiment 9, wherein the alkoxylated alcohol has a formula:

R₃O—(R₄O)ₓR₅ (II)

wherein
R₃ is straight-chain or branched, unsubstituted or substituted C₁-C30 alkyl or straight-chain or branched, unsubstituted or substituted C2-C30 alkenyl,
R₄ in each of the x (R₄O) groups is independently straight-chain or branched, un-substituted or substituted C2-C4 alkylene,
R₅ is hydrogen, or straight-chain or branched, unsubstituted or substituted C1-C30 alkyl straight-chain; and
x is an integer in the range of 1 to 60.
13. The aqueous composition according to embodiment 12, wherein
   R₃ is straight-chain or branched, unsubstituted C10-C14 alkyl;
   R₄ is unsubstituted, straight-chain C2 alkylene;
   R5 is hydrogen and
   x is an integer in the range of 7 to 10
14. The aqueous composition according to embodiment 9, wherein the alkoxylated natural oil is alkoxylated castor oil.
15. The aqueous composition according to embodiment 8, wherein the at least one adjuvant is selected from the group of C9-C11 alkyl polyglucoside, ethoxylated tridecyl alcohols, and ethoxylated castor oil.
16. The aqueous composition according to any one of embodiments 8 to 15, wherein the at least one adjuvant is present an amount of from 0.1 wt. % to 10.0 wt. %, based on the total weight of the aqueous composition.
17. The aqueous composition according to any one of embodiments 1 to 16 further comprising at least one auxiliary agent selected from the group of antifoaming agents, organic and inorganic thickeners, bactericides, antifreeze agents, colorants and adhesives.
18. The aqueous composition according to any one of embodiments 1 to 17 comprising
0.1 wt. % to 1.0 wt. % topramezone,
0.1 wt. % to 10.0 wt. % at least one adjuvant,
0.1 wt. % to 10.0 wt. % at least one auxiliary agent,
at least one buffering agent and
2.0 wt. % to 99.0 wt. % water,
in each case based on the total weight of the aqueous composition,
wherein the pH of the composition is in the range of from 6.5 to 7.5.
19. A method of controlling undesired vegetation, comprising the step of applying the aqueous composition according to any one of embodiments 1 to 18 to plants, their environment and/or seeds.
20. Use of the composition according to any one of embodiments 1 to 19 for controlling undesired vegetation.
21. A method for producing the composition according to any one of embodiments 1 to 19 comprising the step of:
(a) adding from 0.1 wt. % to 1.0 wt. % of topramezone in a buffer solution having a pH range of 6.5 to 7.5.
22. The method according to embodiment 21 further comprising the steps of:
(b) adding at least one adjuvants in the range of from 0.1 wt. % to 10.0 wt. %; and
(c) adding at least one auxiliary agent in the range of from 0.1 wt. % to 10.0 wt. %.
23. A ready to spray formulation according to any one of claims 1 to 18.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Materials: Agnique CSO 36 is ethoxylated castor oil and is a water-soluble emulsifier for solvents and waxes available from BASF under the brand name Agnique® CSO 36. Lutensol® TDA9 is a non-ionic surfactant composed of 9 mole ethylene oxide adduct of tridecyl alcohol from BASF available under the brand name Lutensol® TDA9. Agnique® PG9116 is a C9-C11 alkyl polyglucoside with a degree of polymerization of 1.6 which is available from BASF under the brand name Agnique® PG 9116. Phosphate buffer pH 7.0±0.1 at 25° C. was prepared by known methods. As used here topramezone was obtained from BASF Corp having purity more than 95%.

### Example 1

Process to make the formulation
   1. Topramezone was added to the buffer solution of pH 7.0±0.1 and the resulting solution was stirred for at least 30 minutes.
   2. The adjuvants were added to the above solution and the solution was stirred for one hour to render the final composition.

TABLE 1

| | A | B | C | D | E | F | G |
|---|---|---|---|---|---|---|---|
| | Weight | Weight | Weight | Weight | Weight | Weight | Weight |
| | in gm | in gm | in gm | in gm | in gm | in gm | in gm |
| Topramezone | 2.7 | 1.35 | 1.35 | 1.35 | 1.35 | 1.35 | 1.35 |
| Buffer pH 7.0 | 1500 | 750 | 750 | 750 | 750 | 750 | 750 |
| APG9116 | | 1.6 | | | 7.6 | 7.7 | |
| Lutensol ®TDA9 | | | 7.55 | | 7.6 | | 7.52 |
| Agnique ®CSO36 | | | | 7.55 | | 7.85 | 7.52 |
| Total | 1502.7 | 752.95 | 758.9 | 758.9 | 766.55 | 766.9 | 766.39 |

### Example 2

Stability tests were performed on each of the formulations A to G. The result of the stability tests is depicted in the below table

TABLE 2
Stability data

| | A | B | C | D | E | F | G |
|---|---|---|---|---|---|---|---|
| | Days | Days | Days | Days | Days | Days | Days |
| Room | 168 | 149 | 126 | 126 | 119 | 119 | 119 |
| temperature | | | | | | | |
| 40° C. | 168 | 149 | 126 | 126 | 119 | 119 | 119 |
| 50° C. | 168 | 149 | 70 | 126 | 119 | 119 | 119 |
| 2° C. | 112 | DND | 112 | 112 | 119 | 119 | 119 |
| Freeze thaw | 14 | DND | 14 | 14 | 14 | 14 | 14 |
| cycle (7 cycles) | | | | | | | |

Thus, it can be seen from table no.2 that the formulations were found to be stable.

1. An aqueous composition comprising 0.1 wt. % to 1.0 wt. % topramezone or an agriculturally acceptable salt thereof, based on an overall weight of the aqueous composition, wherein a pH of the composition is in a range of from 6.5 to 7.5.

2. The aqueous composition according to claim 1, wherein an amount of topramezone or an agriculturally acceptable salt thereof is in a range of from 0.1 wt. % to 0.5 wt. %, based on the overall weight of the aqueous composition.

3. The aqueous composition according to claim 1, wherein the pH of the composition is in a range of from 6.8 to 7.2.

4. The aqueous composition according to claim 1, wherein the pH of the composition is in a range of from 6.9 to 7.1.

5. The aqueous composition according to claim 1, comprising at least one buffering agent.

6. The aqueous composition according to claim 5, wherein the at least one buffering agent is selected from the group consisting of phosphate buffer, phosphate-acetate buffer, citrate-phosphate buffer, BES (N,N-bis(2-hydroxyethyl)-2-aminoethanesulfonaic acid)-buffered saline, EBSS(Earle's balanced salt solution) buffer, Hanks balanced buffer solution, HEPPSO (N-(2-hydroxyethyl)piperazine-N′-(2-hydroxypropanesulfonic acid) buffer, Hank's buffer with HEPES, imidazole-HCl buffer, maleic acid buffer, MOPS (3-(N-morpholino)propane-sulfonic acid) buffer, phosphate buffer saline, phosphate buffer, potassium phosphate, TBS Tris buffered saline buffer, and Tris (tris(hydroxymethyl) aminomethane) buffer.

7. The aqueous composition according to claim 1, further comprising at least one adjuvant.

8. The aqueous composition according to claim 7, wherein the at least one adjuvant is a non-ionic surfactant.

9. The aqueous composition according to claim 8, wherein the non-ionic surfactant is selected from the group consisting of alkyl polyglycoside, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols, ethylene oxide/propylene oxide copolymer, and mixtures thereof.

10. The aqueous composition according to claim 9, wherein the alkyl polyglycoside is represented by the formula (I)
R₁O(R₂O)_{b}(Z)ₐ (I)
wherein:
R₁ is straight-chain or branched, unsubstituted or substituted C₄-C₃₀ alkyl or straight-chain or branched, unsubstituted or substituted C₄-C₃₀ alkenyl;
R₂ is straight-chain or branched, unsubstituted or substituted C₂-C₄ alkylene;
b is in a range of 0 to 100;
Z is a saccharide residue having 5 to 6 carbon atoms; and
a is an integer in a range of 1 to 6.

11. The aqueous composition according to claim 10, wherein
R₁ is straight-chain or branched, unsubstituted C₈-C₁₆ alkyl;
b is 0;
Z is glucose; and
a is an integer from 1 to 2.

12. The aqueous composition according to claim 9, wherein the alkoxylated alcohol has a formula:
R₃O—(R₄O)ₓR₅ (II)
wherein
R₃ is straight-chain or branched, unsubstituted or substituted C₁-C₃₀ alkyl or straight-chain or branched, unsubstituted or substituted C₂-C₃₀ alkenyl,
R₄ in each of the x (R₄O) groups is independently straight-chain or branched, un-substituted or substituted C₂-C₄ alkylene,
R₅ is hydrogen, or straight-chain or branched, unsubstituted or substituted C₁-C₃₀ alkyl straight-chain; and
x is an integer in a range of 1 to 60.

13. The aqueous composition according to claim 12, wherein
R₃ is straight-chain or branched, unsubstituted C₁₀-C₁₄ alkyl;
R₄ is unsubstituted, straight-chain C₂ alkylene;
R₅ is hydrogen; and
x is an integer in a range of 7 to 10.

14. The aqueous composition according to claim 9, wherein the alkoxylated natural oil is alkoxylated castor oil.

15. The aqueous composition according to claim 7, wherein the at least one adjuvant is selected from the group consisting of C₉-C₁₁ alkyl polyglucoside, ethoxylated tridecyl alcohols, and ethoxylated castor oil.

16. The aqueous composition according to claim 7, wherein the at least one adjuvant is present in an amount of from 0.1 wt. % to 10.0 wt. %, based on the total weight of the aqueous composition.

17. The aqueous composition according to claim 1, further comprising at least one auxiliary agent selected from the group consisting of antifoaming agents, organic and inorganic thickeners, bactericides, antifreeze agents, colorants, and adhesives.

18. The aqueous composition according claim 1, comprising
0.1 wt. % to 1.0 wt. % topramezone,
0.1 wt. % to 10.0 wt. % of at least one adjuvant,
0.1 wt. % to 10.0 wt. % of at least one auxiliary agent,
at least one buffering agent, and
2.0 wt. % to 99.0 wt. % water,
in each case based on the total weight of the aqueous composition,
wherein the pH of the composition is in a range of from 6.5 to 7.5.

19. A method of controlling undesired vegetation, comprising the step of applying the aqueous composition according to claim 1 to plants, an environment of plants, and/or seeds.

20. A method of using the composition according to claim 1, the method comprising using the composition for controlling undesired vegetation.

21. A method for producing the composition according to claim 1, comprising the step of:
(a) adding from 0.1 wt. % to 1.0 wt. % of topramezone in a buffer solution having a pH range of 6.5 to 7.5.

22. The method according to claim 21 further comprising the steps of:
(b) adding at least one adjuvant in a range of from 0.1 wt. % to 10.0 wt. %; and
(c) adding at least one auxiliary agent in a range of from 0.1 wt. % to 10.0 wt. %.

23. A ready to spray formulation according to claim 1.
